(19) United States
(12) Patent Application Publication
(10) Pub. No.: US 2021/0073890 A1
(43) Pub. Date: Mar. 11, 2021

(54) CATALOG-BASED IMAGE RECOMMENDATIONS

(71) Applicant: Kohl's, Inc., Menomonee Falls, WI (US)

(72) Inventors: Alan Lee, Sunnyvale, CA (US); Jagadeesh Patchala, San Jose, CA (US); Ritaja Sur, Sunnyvale, CA (US); Ankit Swarnkar, San Jose, CA (US); Xiaoyu Jin, Milipitas, CA (US); Ragnar Hagen Lesch, Fremont, CA (US)

(21) Appl. No.: 17/011,188

(22) Filed: Sep. 3, 2020

Related U.S. Application Data
(60) Provisional application No. 62/896,485, filed on Sep. 5, 2019.

(51) Int. Cl. G06Q 30/06; G06N 3/08; G06F 16/53; G06K 9/62; G06K 9/46

(52) U.S. Cl. CPC G06Q 30/0631; G06N 3/08; G06F 16/53; G06K 9/627; G06K 9/6215; G06K 9/46; G06Q 30/0603

(57) ABSTRACT

An image recommendation system extracts multiple sets of feature vectors from each of a plurality of images in an image catalog using multiple image classification algorithms. For a first image in the plurality of images, the recommendation system generates multiple similarity scores between the first image and each of one or more other images in the image catalog based on the feature vectors extracted from the first image and the one or more other images using each of the multiple image classification algorithms. A first set of weights is applied to the multiple similarity scores to generate respective weighted similarity scores between the first image and each of the one or more other images. The weighted similarity scores are stored, and used to select images that are similar to the first image.

### CROSS-REFERENCE TO RELATED APPLICATION

This application claims the benefit of U.S. Provisional Patent Application No. 62/896,485, filed Sep. 5, 2019, which is incorporated herein by reference in its entirety.

### TECHNICAL FIELD

The present technology generally relates to catalog-based image recommendations and associated systems and methods.

### BACKGROUND

Consumers often shop visually. Frequently, a person who sees an eye-catching product on a retail website will try to find visually similar products in the website. Although there are existing techniques for determining similarity between two images, these techniques are not currently suited for online retailer recommendation systems. Some algorithms for generating similarity scores between images may have high accuracy for some types of images, enabling a recommendation system to select images that are of interest to a consumer. However, these algorithms may have significantly lower accuracy for other types of images, causing the recommendation system to produce poor recommendations. For a website selling many different types of products, existing algorithms fail to generate useful image-based recommendations across all of the website's products.

### BRIEF DESCRIPTION OF THE DRAWINGS

FIG. 1 is a block diagram showing some of the components typically incorporated in at least some of the computer systems and other devices on which the catalog-based image recommendation system operates.

FIG. 2 is a system diagram illustrating an example of a computing environment in which the catalog-based image recommendation system operates in some embodiments.

FIG. 3 is a block diagram illustrating a catalog-based image recommendation system.

FIG. 4 is a flowchart illustrating a process for generating similarity scores for pairs of images in an image catalog.

FIG. 5 is a flowchart illustrating a process for generating category-based weights.

FIG. 6 is a flowchart illustrating a process for generating image-based recommendations using weighted similarity scores.

### DETAILED DESCRIPTION

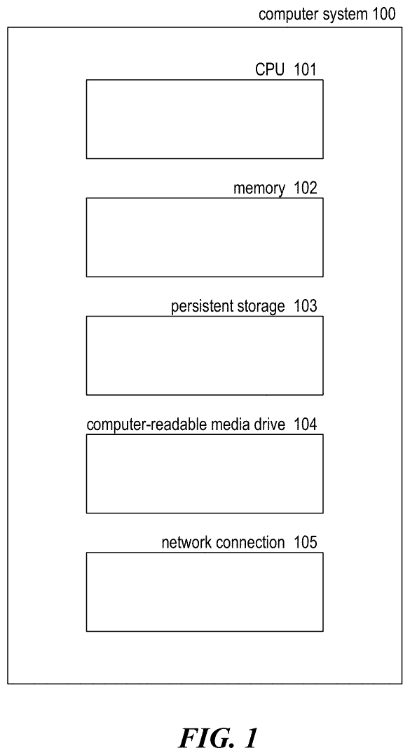

Aspects of the present disclosure are directed generally to catalog-based image recommendations and associated systems and methods. Specific details of several embodiments of the present technology are described herein with reference to FIGS. 1-6. The present technology, however, can be practiced without some of these specific details. In some instances, well-known structures and techniques often associated with system architecture have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

### System Overview

A catalog-based image recommendation system uses multiple image classification algorithms to extract feature vectors from images in an image catalog. The image catalog can include images from a variety of image categories. For example, the image catalog can contain images of products sold through an online retail website, and the images can be categorized according to the type of product shown in each image. Some of the image classification algorithms applied by the image recommendation system may be better for some of the image categories than for others. Image similarity measurements generated using a more accurate algorithm for the image's category produce more useful recommendations for a human user, while similarity measurements generated using algorithms that are less accurate for the image's category produce less useful recommendations. One image classification algorithm may be highly accurate for a first category in the image catalog, but relatively inaccurate for a second category in the image catalog.

To balance the varying accuracy of the multiple image classification algorithms for each category of image, the image recommendation system calculates and applies a set of weights to the outputs of the image classification algorithms. The set of weights is particular to an image category, and causes the output of more accurate algorithms for the category to have a greater influence on similarity determination than the output of less-accurate algorithms. The image recommendation system therefore flexibly applies the same set of image classification algorithms to all categories of images in the image catalog while generating more accurate similarity measurements. The image recommendation system is also scalable, allowing new categories of images to be processed in the same way as preexisting image categories without retooling the existing image classification algorithms.

FIG. 1 is a block diagram showing some of the components typically incorporated in at least some of the computer systems and other devices on which the catalog-based image recommendation system operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the catalog-based image recommendation system and associated data; an operating system including a kernel, and device drivers; a persistent storage device 103, such as a hard drive or flash drive for persistently storing programs and data; a computer-readable media drive 104 that is a tangible storage means that does not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the image recommendation system, those skilled in the art will appreciate that the catalog-based image recommendation system can be implemented using devices of various types and configurations, and having various components.

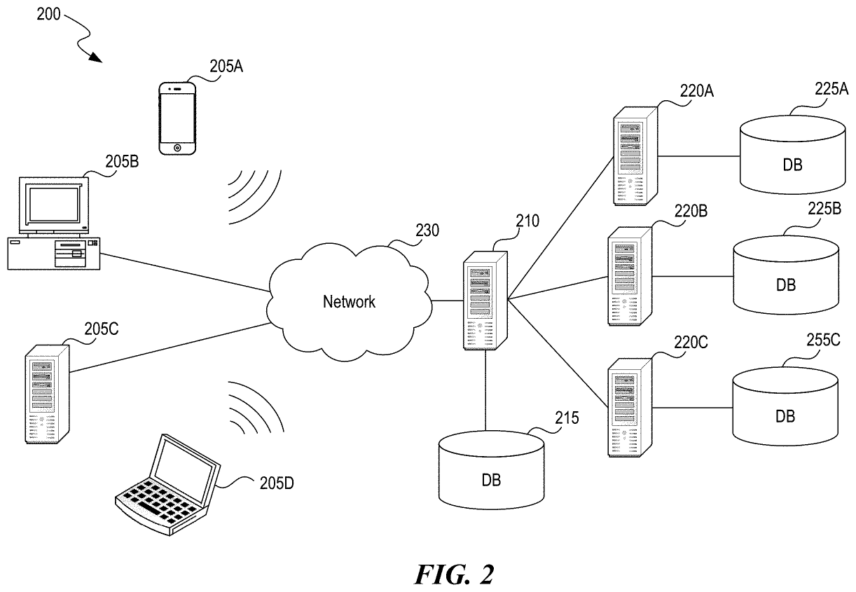

FIG. 2 is a system diagram illustrating an example of a computing environment in which the catalog-based image recommendation system operates. In some implementations, environment 200 includes one or more client computing devices 205A-D, examples of which can include computer system 100. Client computing devices 205 operate in a networked environment using logical connections 210 through network 230 to one or more remote computers, such as a server computing device.

In some implementations, server 210 is an edge server which receives client requests and coordinates fulfillment of those requests through other servers, such as servers 220A-C. In some implementations, server computing devices 210 and 220 comprise computing systems, such as computer system 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. In some implementations, servers (210, 220A-C) connect to a corresponding database (215, 225A-C). As discussed above, each server 220 can correspond to a group of servers, and each of these servers can share a database or can have its own database. Databases 215 and 225 warehouse (e.g., store) information such as catalog data. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but it can also be other wired or wireless networks. In some implementations, network 230 is the Internet or some other public or private network. Client computing devices 205 are connected to network 230 through a network interface, such as by wired or wireless communication. While the connections between server 210 and servers 220 are shown as separate connections, these connections can be any kind of local, wide area, wired, or wireless network, including network 230 or a separate public or private network.

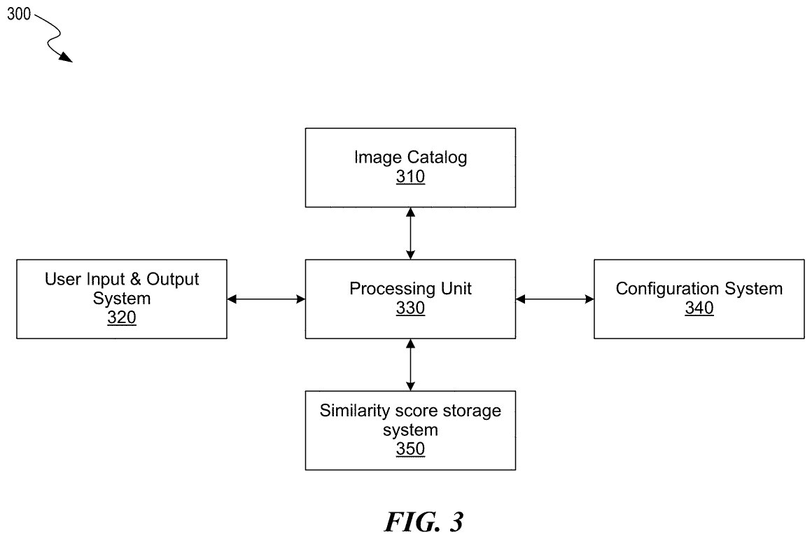

FIG. 3 is a block diagram illustrating a catalog-based image recommendation system 300. As shown in FIG. 3, the catalog-based image recommendation system 300 can include an image catalog 310, a user input and output (I/O) system 320, a processing unit 330, a configuration system 340, and a similarity score store 350. Other embodiments of the image recommendation system 300 can include additional, fewer, or different components, and functionality can be distributed differently between the components.

The image catalog 310 is a computer-readable storage of images. Images are stored in the image catalog in a computer-readable image format, such as .png, .jpeg, .jpg, .bmp, or binary stream. Each image can be associated with a category. In one example use of the image recommendation system 300, the image catalog 310 contains images of products sold through an online retailer, and the category associated with each image represents a type of product in the image. For example, images of clothing can be associated with categories such as shoes, shirts, pants, dresses, or bags. Alternatively, images can be categorized based on attributes of the content of the images. Example attribute-based categories include images of items that have a brown color, items that have a stripes pattern, or items that feature a logo. Any of a variety of other categories can be associated with the images in the image catalog 310, and the image catalog 310 may contain any number of categories of images.

The user I/O system 320 receives user requests and outputs data to the users in response to the requests. The user I/O system 320 generates interfaces for display to the user, for example via a user device, that enable the user to input an image or images for similarity matching and view similar images returned as a result of similarity matching. Examples of interfaces of the user I/O system 320 include, for example, web interfaces, desktop applications, mobile applications, application interfaces (APIs) without any graphical user interface, or computer-readable documents.

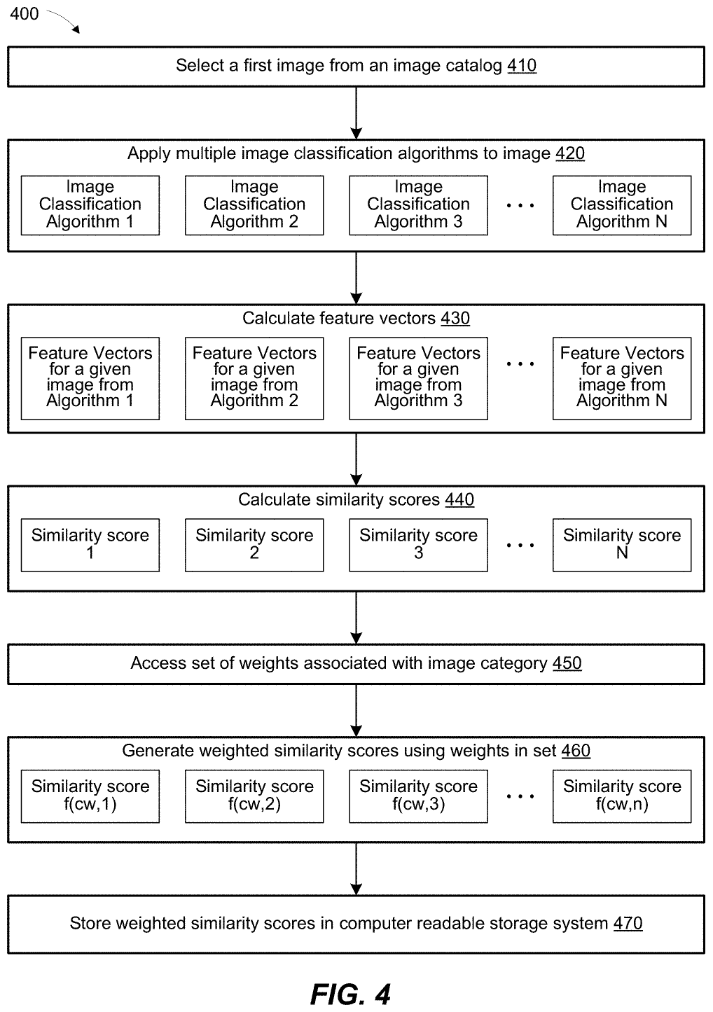

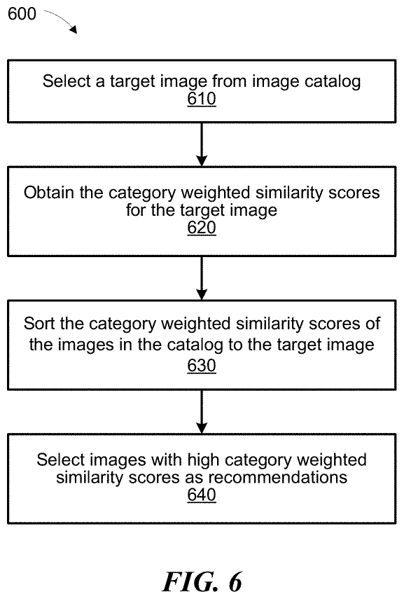

The processing unit 330 calculates similarities between images in the image catalog 310 and stores the calculated similarities in the similarity score store 350. The processing unit 330 can additionally generate image-based recommendations using the calculated similarities, for example in response to user queries for images that are similar to a target image. Processes performed by the processing unit 330 to calculate the similarity scores and use the scores to generate image recommendations are described, respectively, with respect to FIGS. 4 and 6.

The configuration system 340 applies system configurations to improve accuracy of the recommendations output by the image recommendation system 300. These configurations can include weights that are associated with each category of images and that define relative weighting of the outputs of each image classification algorithm applied by the processing unit 330. The configuration system 340 can, in some embodiments, dynamically determine the weights for each image category by evaluating accuracy metrics associated with the similarity scores output by the image classification algorithms when applied to images in the image category. Generally, those algorithms that produce more accurate similarity scores for a given image category can be assigned higher weights, while those algorithms that generate less accurate similarity scores are assigned lower weights. By dynamically generating the weights, the configuration system 340 enables the processing unit 330 to flexibly apply the same image classification algorithms to any image in the image catalog, while accounting for varying accuracy of the algorithms for different image categories.

The similarity score store 350 comprises one or more computer-readable storage mechanisms to store the calculated similarity scores for future use. The storage could be a persistent or a non-persistent storage with fast access. Examples of persistent storage include, but are not limited to, a database system or a file system. Examples of non-persistent storage include, but are not limited to, in-memory storage, CPU cache storage, or GPU cache storage.

### Generating Image Similarity Scores

FIG. 4 is a flowchart illustrating a process 400 for generating similarity scores for pairs of images in an image catalog, according to some embodiments. The process 400 can be performed by the processing unit 330. Other embodiments of the process 400 can include additional, fewer, or different steps, or can perform the steps in different orders.

As shown in FIG. 4, the processing unit 330 selects, at block 410, a first image from an image catalog. The first image is associated with a category. For example, the first image may be tagged with metadata indicating that it is an image of a product falling into the category of “dresses.”

At block 420, the processing unit 330 applies multiple image classification algorithms to the first image to extract respective sets of features from the first image. The multiple image classification algorithms can include different types of algorithms, such as a combination of neural network-based algorithms and visual descriptor-based algorithms. Additionally or alternatively, the multiple image classification algorithms can include algorithms that are trained differently, such as a first neural network trained with a first type of training data and a second neural network trained with a second type of training date. Existing image classification algorithms, new customized algorithms developed for the image catalog, or a combination of existing and customized algorithms can be used among the multiple algorithms applied to the first image. Collectively, the multiple image classification algorithms extract different feature sets from the first image. At block 430, the processing unit 330 calculates a feature vector for the first image using the features output by each algorithm.

As an example first algorithm applied at block 420 and used to extract feature vectors at block 430, the neural network-based image classification algorithm AlexNet can be applied to the first image. An example process for using AlexNet to extract features from the first image is as follows:
1. Convert the first image into a vector by considering a feature vector output at convolution layer 5 of AlexNet.
2. Convert the first image into a vector by considering a feature vector output at fully connected layer 6 of AlexNet.
3. Preprocess the first image to detect edges in the image using a canny edge detection method. Next, calculate feature vectors for the preprocessed first image using convolution layer 5 of AlexNet.
4. Preprocess the first image to convert it into a grayscale image. Next, calculate a feature vector for the preprocessed first image using convolution layer 5 of AlexNet.
5. Preprocess the first image to detect visual descriptors using a Local Binary Pattern method. Local Binary Pattern (LBP) method is used for texture detection in images. The LBP operator forms labels for the image pixels by thresholding the 3×3 neighborhood of each pixel with the center value and considering the result as a binary number. In this way for 8 neighbors, 2⁸=256 different labels can then be used as a texture descriptor. These labels are then converted to decimal by multiplying and summing by powers of 2. Finally, the preprocessed first image is converted into a vector by considering the feature vector output at convolution layer 5 of AlexNet.

Another example algorithm of the multiple image classification algorithms applied to the first image is the neural network-based VGG16. An example process for using VGG16 is as follows:
1. Calculate a feature vector for the first image image by performing average pooling of convolution5_3 layer of VGG16 Net. Distances between the feature vectors generated from the first image and one or more other images can be calculated using a nearest neighbors method.
2. Preprocess the first image to detect its visual descriptors using Local Binary

Pattern method, Next, calculate a feature vector for the preprocessed first image by performing average pooling of convolution5_3 layer of VGG16 Net.

As an example visual descriptor-based algorithm that can be applied at block 420, the processing unit 330 can use a Bag of Visual Words algorithm. Applying this algorithm can include the following process:
1. Preprocess the first image to detect its visual descriptors using Oriented FAST and Rotated BRIEF (ORB) method.
2. Cluster the descriptors using, for example, the k-means clustering algorithm.

Each cluster center represents a feature or visual word. The histogram of visual words can be used as a feature vector for the first image.

Another example visual descriptor-based algorithm is Fisher Vectors. To apply the Fisher Vectors algorithm, the processing unit 330 can perform a process including:
1. Use a probability density function (for example, a Gaussian Mixture Model) to model visual vocabulary of the first image.
2. Compute a gradient of a log likelihood with respect to the parameters of the model to represent the first image. The Fisher Vector is the concatenation of these partial derivatives, describing a direction in which parameters of the model should be modified to best fit the data. This representation has the advantage to give similar or even better classification performance than Bag of Visual Words obtained with supervised visual vocabularies, being at the same time class independent. The Fisher Vector can be used as a feature vector for the first image.

At block 440, the processing unit 330 calculates similarity scores between the first image and one or more other images in the image catalog. For each pair of images, the processing unit 330 calculates multiple similarity scores. As illustrated in FIG. 4, a similarity score is generated using the feature vectors output by each image classification algorithm. For example, the processing unit 330 calculates a first similarity score between the first image and a second image using the feature vector of the first image output by the first algorithm and the feature vector of the second image output by the first algorithm. Likewise, a second similarity score can be calculated using the feature vectors of the first and second images output by the second algorithm, and so on for each algorithm applied at block 420. The processing unit 330 can calculate similarity scores using any metric quantifying the similarity between the feature vectors of two images, such as cosine similarity, correlation coefficient, or Jaccard similarity.

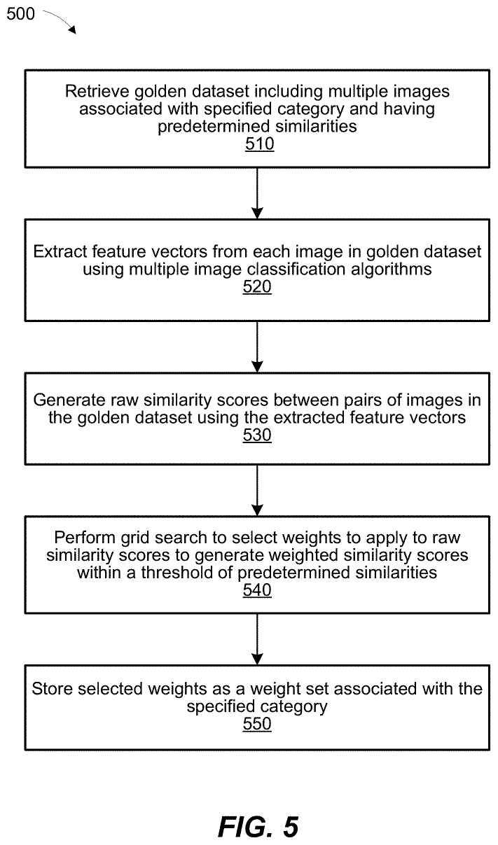

At block 450, the processing unit 330 accesses a set of weights associated with the category of the first image. The set of weights includes multiple weights, each of which corresponds to one of the multiple image classification algorithms applied to the first image. Collectively, the set of weights define relative influence of each image classification algorithm for determining similarity between images in a given category. For example, each weight in the set has a value between zero and one, and the values of the weights may together sum to a value of one. A process for generating the set of weights is described with respect to FIG. 5.

At block 460, the processing unit 330 generates weighted similarity scores by applying the weights in the set of weights to the similarity scores calculated between the first image and one or more other images. For example, the processing unit 330 multiplies each similarity score by the weight that corresponds to the image classification algorithm from which the feature vectors used to generate the similarity score were derived. The output of block 460 is a set of weighted similarity scores between each pair of images. The processing unit 330 stores the sets of weighted similarity scores in a computer readable storage system at block 470.

The processing unit 330 repeats the process shown in FIG. 4 for each image in the image catalog, generating a set of weighted similarity scores between each image and each of the other images in the catalog that are in the same category. The weighted similarity scores are stored for use by the recommendation system 300.

The set of weights applied by the processing unit 330 to generate weighted similarity scores can be particular to the category of the first image, representing relative influences of the multiple image classification algorithms for determining the image similarities for the category. One embodiment of a process 500 for generating the set of weights is illustrated in FIG. 5. The process 500 can be performed by the configuration system 340. Other embodiments of the process 500 include additional, fewer, or different steps, or perform the steps in different orders. The process 500 can be performed for each category of images in the image catalog. Furthermore, the process 500 can be performed whenever an image classification algorithm is added to or removed from the set of multiple algorithms applied to images (e.g., as described with respect to block 420 in FIG. 4). Accordingly, the image recommendation system 300 is scalable to include additional image categories or additional algorithms by repeating the process 500

As shown in FIG. 5, the configuration system 340 retrieves a golden dataset at block 510. The golden dataset is a set of images associated with a specified category and that have known similarities to one another.

At block 520, the configuration system 340 applies multiple image classification algorithms to each image in the golden dataset to extract sets of feature vectors from each image. The process to apply the algorithms and extract feature vectors can be similar to that described with respect to block 420. At block 530, the configuration system 340 generates raw similarity scores between pairs of images in the golden dataset using the extracted feature vectors. Each pair of images can be associated with multiple similarity scores, where each similarity score quantifies a similarity of the feature vectors extracted from the images in the pair by one of the multiple image classification algorithms.

Starting with a weight set containing initial weight values, the configuration system 340 performs a grid search at block 540 to select weights to apply to the raw similarity scores of the golden dataset. During the grid search, the configuration system 340 searches for weight values that, when applied to the raw similarity scores, will generate weighted similarity scores within a threshold of the predetermined similarities of the images. In some embodiments, the weights in the set are constrained to a fixed sum, such as a value of one. The grid search adjusts and tests the values of the weights while keeping the sum of the weights within the constraint.

Once the weight values have been selected, at block 550, the configuration system 340 stores the selected weights as a weight set associated with the category of the golden dataset. The stored weight set can be retrieved for use by the processing unit 330 for generating weighted similarity scores between images of unknown similarity, as described with respect to FIG. 4.

### Image-Based Recommendations

The catalog-based image recommendation system 300 uses the weighted similarity scores generated and stored by the processing unit 330 to generate image recommendations. FIG. 6 is a flowchart illustrating a process 600 for generating image-based recommendations using the weighted similarity scores, according to some embodiments. The process 600 can be performed by the image recommendation system 300.

At block 610, the image recommendation system 300 selects a target image from the image catalog. In some cases, the target image may be selected in response to an explicit user query that specifies an image and request images that are similar to the specified image. In other cases, the target image may be selected in response to an implicit user request. For example, if a user is viewing a product's webpage through an online retail website, the image recommendation system 300 may select an image of the product as the target image in order to generate a set of recommended images for display on the product's webpage.

At block 620, the image recommendation system 300 retrieves the weighted similarity scores for the target image. As discussed above, the weighted similarity scores include multiple similarity scores between the target image and each of one or more other images in the catalog, where each of the multiple scores is weighted by a weight value that is particular to the category of the target image and that corresponds to an image classification algorithm that generated the feature vectors from which the similarity score was calculated.

At block 630, the recommendation system 300 sorts the retrieved similarity scores and selects, at block 640, one or more recommendations based on the sorted scores. In some embodiments, the recommendation system 300 selects a specified number of images that have the highest weighted similarity scores to the target image. For example, the recommendation system 300 identifies the ten highest weighted similarity scores, and selects the images corresponding to the ten identified scores as the recommended images. The recommended images can be output to the user.

Embodiments of the catalog-based image recommendation system described herein provide a flexible framework for generating image recommendations across multiple categories of images. By generating category-specific weightings, the recommendation system favors the outputs of image classification algorithms that better represent human-observable similarities between images in a given category.

### Conclusion

The above detailed description of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments can perform steps in a different order. The various embodiments described herein can also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms can also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein.

We claim:

1. A method comprising:
extracting multiple sets of feature vectors from each of a plurality of images in an image catalog using, for each of the plurality of images, multiple image classification algorithms;
for a first image in the plurality of images:
generating multiple similarity scores between the first image and each of one or more other images in the image catalog based on the feature vectors extracted from the first image and the one or more other images using each of the multiple image classification algorithms;
applying a first set of weights to the multiple similarity scores to generate respective weighted similarity scores between the first image and each of the one or more other images; and
storing the weighted similarity scores;
receiving a query from a user for images similar to the first image; and
in response to the query, selecting similar images for output to the user from the one or more other images based on the weighted similarity scores.

2. The method of claim 1, wherein the first image is associated with a first category, and wherein the method further comprises, for a second image associated with a second category:
generating a second set of similarity scores between the second image and one or more other images in the image catalog based on the feature vectors extracted from the second image and the one or more other images using each of the multiple image classification algorithms; and
applying a second set of weights to the second set of similarity scores to generate respective weighted similarity scores between the second image and each of the one or more other images;
wherein the second set of weights are associated with the second category and the second set of weights is different from the first set of weights.

3. The method of claim 2, further comprising selecting the first set of weights based at least in part on similarity scores generated by applying the multiple image classification algorithms to a golden set of images associated with the first category.

4. The method of claim 3, wherein the golden set of images includes images having predetermined similarities, and wherein generating the first set of weights comprises:
extracting, by the multiple image classification algorithms, feature vectors from each of a plurality of images in the golden set of images;
generating raw similarity scores between pairs of images in the golden set using the feature vectors extracted from each image in the pairs;
performing a grid search to select weights to apply to the raw similarity scores to generate weighted similarities that are within a threshold of the predetermined similarities; and
storing the selected weights as the first set of weights.

5. The method of claim 2, wherein the image catalog includes images of products sold through an online retail website, and wherein the first and second categories represent first and second categories of the products sold through the online retail website.

6. The method of claim 1, wherein the first set of weights comprises a weight corresponding to each of the image classification algorithms, and wherein at least two weights in the first set of weights are different.

7. The method of claim 6, wherein the weights corresponding to each of the image classification algorithms each have a value between zero and one, and wherein the first set of weights together sum to a value of one.

8. The method of claim 1, wherein the image catalog includes images of products sold through an online retail website, wherein the first image is an image of a product displayed on a product webpage of the online retail website, and wherein the method further comprises:
outputting the similar images for display to the user via the product webpage of the online retail website.

9. The method of claim 1, wherein the multiple image classification algorithms comprise at least one neural network-based algorithm and at least one visual descriptor-based algorithm.

10. The method of claim 1, further comprising preprocessing each of the plurality of images to generate preprocessed images, wherein at least one of the multiple image classification algorithms is applied to the preprocessed images.

11. A non-transitory computer readable storage medium storing executable computer program code, the computer program code when executed by a processor causing the processor to, for a target image selected from an image catalog:
access a plurality of similarity scores generated based on feature vectors extracted from the target image and a plurality of other images in the image catalog by multiple image classification algorithms applied to the images, the plurality of similarity scores including at least two similarity scores between the target image and another image that were each generated using feature vectors extracted from the target image and the other image by at least two different image classification algorithms;
retrieve a set of weights corresponding to a category of the target image, the retrieved set of weights including a weight to apply to the similarity score generated based on each of the at least two different image classification algorithms;
apply the set of weights to the plurality of similarity scores to generate weighted similarity scores between the target image and the plurality of other images in the image catalog; and store the weighted similarity scores.

12. The non-transitory computer readable storage medium of claim 11, wherein the target image is associated with a first category, and wherein the method further comprises, for a second image associated with a second category:
generating a second set of similarity scores between the second image and one or more other images in the image catalog based on the feature vectors extracted from the second image and the one or more other images using each of the multiple image classification algorithms; and
applying a second set of weights to the second set of similarity scores to generate respective weighted similarity scores between the second image and each of the one or more other images;
wherein the second set of weights are associated with the second category and the second set of weights is different from the first set of weights.

13. The non-transitory computer readable storage medium of claim 12, further comprising selecting the second set of weights based at least in part on similarity scores generated by applying the multiple image classification algorithms to a golden set of images associated with the second category.

14. The non-transitory computer readable storage medium of claim 13, wherein the golden set of images includes images having predetermined similarities, and wherein generating the second set of weights comprises:
extracting, by the multiple image classification algorithms, feature vectors from each of a plurality of images in the golden set of images;
generating raw similarity scores between pairs of images in the golden set using the feature vectors extracted from each image in the pairs;
performing a grid search to select weights to apply to the raw similarity scores to generate weighted similarities that are within a threshold of the predetermined similarities; and
storing the selected weights as the second set of weights.

15. The non-transitory computer readable storage medium of claim 12, wherein the second set of weights comprises a weight corresponding to each of the image classification algorithms, and wherein at least two weights in the second set of weights are different.

16. The non-transitory computer readable storage medium of claim 12, wherein the image catalog includes images of products sold through an online retail website, and wherein the first and second categories represent first and second categories of the products sold through the online retail website.

17. The non-transitory computer readable storage medium of claim 16, wherein the computer program code further causes the processor to:
select one or more images that are similar to the target image using the weighted similarity scores; and
outputting the similar images for display to a user via product webpage of the online retail website that displays a product associated with the target image.

18. The non-transitory computer readable storage medium of claim 11, wherein the multiple image classification algorithms comprise at least one neural network-based algorithm and at least one visual descriptor-based algorithm.

19. An image recommendation system, comprising:
a processor; and
a non-transitory computer readable storage medium storing executable computer program code, the computer program code when executed by the processor causing the processor to:
receive a request to identify images similar to a target image in an image catalog, the target image associated with a specified category;
access category weighted similarity scores associated with the target image, the category weighted similarity scores including multiple weighted similarity scores between the target image and each of one or more other images in the image catalog, wherein each weighted similarity score is calculated using a weight value that is particular to the specified category and that corresponds to an image classification algorithm that generate feature vectors from which the respective weighted similarity score was calculated;
select, based on the category weighted similarity scores, one or more images from the image catalog that are similar to the target image; and
output the selected images in response to the request.

20. The image recommendation system of claim 19, wherein the image catalog includes images of products sold through an online retail website, and wherein the specified category represents a category of the products sold through the online retail website.
